(19) United States
(12) Patent Application Publication
(10) Pub. No.: US 2024/0313667 A1
(43) Pub. Date: Sep. 19, 2024

(54) INTEGRATED RECTIFIER MODULE

(71) Applicant: Navitas Semiconductor Limited, Dublin (IE)

(72) Inventors: Root Zhao, Hangzhou (CN); Tao Wei, Hangzhou (CN); Wenhao Yu, Hangzhou (CN); Yao Fowler, Hangzhou (CN)

(73) Assignee: Navitas Semiconductor Limited, Dublin (IE)

(21) Appl. No.: 18/600,598

(22) Filed: Mar. 8, 2024

(30) Foreign Application Priority Data
Mar. 14, 2023 (CN) 202310246675.3

(51) Int. Cl. H02M 7/00; H01F 27/28

(52) U.S. Cl. CPC H02M 7/003; H01F 27/2804

(57) ABSTRACT

A synchronous rectifier module includes a transformer sandwiched between a first circuit board and a second circuit board. A first plurality of switches are disposed on a first side of the first circuit board and form a first synchronous rectifier circuit, and a second plurality of switches are disposed on a second side of the first circuit board and form a second synchronous rectifier circuit. A third plurality of switches are disposed on a first side of the second circuit board and form a third synchronous rectifier circuit, and a fourth plurality of switches are disposed on a second side of the second circuit board and form a fourth synchronous rectifier circuit. The first, second, third and fourth synchronous rectifier circuits are each connected to secondary windings of the transformer.

### CROSS-REFERENCES TO OTHER APPLICATIONS

This application claims priority to Chinese Provisional Patent Appl. No. 202310246675.3, for “INTEGRATED RECTIFIER MODULE” filed on Mar. 14, 2023, which is hereby incorporated by reference in entirety for all purposes.

### FIELD

The present invention relates to the technical field of synchronous rectification, and specifically to a synchronous rectifier module that includes an integrated transformer.

### BACKGROUND

Currently there are a wide variety of electronic devices that require rectification of AC power. Many of these electronic devices require increased power density and efficiency to meet consumer needs. New methods of rectifying AC power and/or packaging rectifier circuits are needed to address these needs.

### SUMMARY

Some embodiments of the present disclosure relate to electronic modules that rectify an AC voltage. In particular, a new architecture for an AC rectification module is disclosed that provides improved efficiency and power density. A first circuit board includes a first plurality of power switches and a second circuit board includes a second plurality of power switches. A transformer is sandwiched between the first and second circuit boards and is electrically connected to each circuit board. The transformer includes a primary winding magnetically coupled to first and second secondary windings, wherein the first secondary winding is connected to the first plurality of power switches and wherein the second secondary winding is connected to the second plurality of power switches. A magnetic core extends through the primary winding and through the first and second secondary windings. The primary winding receives an AC voltage and the first and second pluralities of power switches rectify the AC voltage. The close proximity of the secondary windings to the first and second pluralities of switches reduces parasitic inductance and capacitance (e.g., resulting in improved efficiency) and enables a compact architecture.

In some embodiments a power conversion module includes a first circuit board including a first plurality of power switches and a second circuit board including a second plurality of power switches. A transformer includes: a primary winding magnetically coupled to first and second secondary windings, where the first secondary winding is connected to the first plurality of power switches and where the second secondary winding is connected to the second plurality of power switches; and a magnetic core extending through the primary winding and through the first and second secondary windings. The primary winding receives an AC voltage and the first plurality of power switches and the second plurality of power switches rectify the AC voltage.

In some embodiments the transformer is positioned between the first circuit board and the second circuit board. In various embodiments the transformer further includes: a third secondary winding connected to the first plurality of power switches and a fourth secondary winding connected to the second plurality of power switches. In some embodiments the first secondary winding is positioned adjacent the second secondary winding and the third secondary winding is positioned adjacent the fourth secondary winding. In various embodiments at least a portion of the primary winding is positioned between the first secondary winding and the third secondary winding. In some embodiments a first set of the first plurality of power switches are connected in parallel and a second set of the second plurality of power switches are connected in parallel. In various embodiments the power conversion module may include electrical conductors electrically coupled to the first and second circuit boards. In some embodiments the first and second pluralities of power switches may include III-V semiconductor devices.

In some embodiments the power conversion module includes a first circuit board including a first plurality of power switches and a second circuit board including a second plurality of power switches. A transformer includes a primary winding coupled to first, second, third, fourth, fifth, sixth, seventh and eighth secondary windings, where the first secondary winding is coupled in series with the second secondary winding via the first circuit board, the third secondary winding is coupled in series with the fourth secondary winding via the first circuit board, the fifth secondary winding is coupled in series with the sixth secondary winding via the second circuit board and the seventh secondary winding is coupled in series with the eighth secondary winding via the second circuit board. The primary winding receives an AC voltage and the first and second pluralities of power switches rectify the AC voltage.

In some embodiments the transformer is positioned between the first circuit board and the second circuit board. In various embodiments the first, second, third and fourth secondary windings are connected to the first plurality of power switches and the fifth, sixth, seventh and eighth secondary windings are connected to the second plurality of power switches. In some embodiments the first secondary winding is positioned adjacent the third secondary winding and the second secondary winding is positioned adjacent the fourth secondary winding. In various embodiments at least a portion of the primary winding is positioned between the first secondary winding and the third secondary winding. In some embodiments a first set of the first plurality of power switches are connected in parallel and a second set of the second plurality of power switches are connected in parallel. In various embodiments the power conversion module may include first and second electrical conductors electrically coupled to the first and second circuit boards. In some embodiments the first and second pluralities of power switches may include III-V semiconductor devices.

In some embodiments a method of forming a power conversion module includes forming a first circuit board and attaching a first plurality of power switches to the first circuit board. The method also includes forming a second circuit board and attaching a second plurality of power switches to the second circuit board. The method also includes forming a transformer including a primary winding coupled to first, second, third, fourth, fifth, sixth, seventh and eighth secondary windings. The method also includes coupling the first secondary winding in series with the second secondary winding via the first circuit board. The method also includes coupling the third secondary winding in series with the fourth secondary winding via the first circuit board. The method also includes coupling the fifth secondary winding in series with the sixth secondary winding via the second circuit board. The method also includes coupling the seventh secondary winding in series with the eighth secondary winding via the second circuit board. The method also includes receiving an AC voltage with the primary winding and rectifying the AC voltage with the first and second pluralities of power switches.

In some embodiments the method may include inserting a ferromagnetic material within the primary winding and the first through eighth secondary windings. In various embodiments the transformer is positioned between the first circuit board and the second circuit board. In some embodiments the method may include forming the first and second pluralities of switches from a III-V semiconductor material.

Numerous benefits are achieved by way of the present invention over conventional techniques. For example, embodiments of the present invention provide the ability to increase efficiency and power density for an AC to DC converter. These and other embodiments of the invention along with many of its advantages and features are described in more detail in conjunction with the text below and attached figures.

To better understand the nature and advantages of the present disclosure, reference should be made to the following description and the accompanying figures. It is to be understood, however, that each of the figures is provided for the purpose of illustration only and is not intended as a definition of the limits of the scope of the present disclosure. Also, as a general rule, and unless it is evident to the contrary from the description, where elements in different figures use identical reference numbers, the elements are generally either identical or at least similar in function or purpose.

### BRIEF DESCRIPTION OF THE DRAWINGS

FIG. 1 illustrates a simplified block diagram of a compact integrated synchronous rectifier module according to embodiments of the disclosure;

FIG. 2 illustrates a simplified assembly drawing of a compact integrated synchronous rectifier module according to embodiments of the disclosure;

FIG. 3 illustrates a simplified exploded view of the compact integrated synchronous rectifier module illustrated in FIG. 2;

FIG. 4 illustrates a simplified schematic of a top portion of a top circuit board of the compact integrated synchronous rectifier module illustrated in FIGS. 2 and 3;

FIG. 5 illustrates a simplified schematic of a bottom portion of the top circuit board of the compact integrated synchronous rectifier module illustrated in FIGS. 2 and 3;

FIG. 6 illustrates a simplified schematic of a top portion of the lower, main circuit board of the compact integrated synchronous rectifier module illustrated in FIGS. 2 and 3;

FIG. 7 illustrates a simplified schematic of a bottom portion of the lower, main circuit board of the compact integrated synchronous rectifier module illustrated in FIGS. 2 and 3;

FIG. 8 illustrates a simplified assembly drawing of the compact integrated synchronous rectifier shown in FIGS. 2-7 with a connector board;

FIG. 9 illustrates a simplified exploded view of the compact integrated synchronous rectifier module shown in FIG. 8; and

FIG. 10 illustrates a simplified isometric drawing of another embodiment of a compact integrated synchronous rectifier module.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

Techniques disclosed herein relate generally to switching power supplies. More specifically, techniques disclosed herein related to a compact integrated synchronous rectifier module with increased power density and efficiency. The synchronous rectifier module comprises a series of parallel transformers sandwiched between a top synchronous rectification circuit board that includes paralleled transistors on top and bottom surfaces, and a bottom synchronous rectification circuit board that also includes paralleled transistors on top and bottom surfaces. The close proximity of the transformer and transistors enables more efficient switching (e.g., reduced parasitics/reduced power loss) and a more compact architecture as compared to previous designs.

In order to better appreciate the features and aspects of synchronous rectifier modules with increased power density and efficiency according to the present disclosure, further context for the disclosure is provided in the following section by discussing one particular implementation of synchronous rectifier module according to embodiments of the present disclosure. These embodiments are for example only and other embodiments can have a different construction or geometry.

Several illustrative embodiments will now be described with respect to the accompanying drawings, which form a part hereof. The ensuing description provides embodiment(s) only and is not intended to limit the scope, applicability, or configuration of the disclosure. Rather, the ensuing description of the embodiment(s) will provide those skilled in the art with an enabling description for implementing one or more embodiments. It is understood that various changes may be made in the function and arrangement of elements without departing from the spirit and scope of this disclosure. In the following description, for the purposes of explanation, specific details are set forth in order to provide a thorough understanding of certain inventive embodiments. However, it will be apparent that various embodiments may be practiced without these specific details. The figures and description are not intended to be restrictive. The word “example” or “exemplary” is used herein to mean “serving as an example, instance, or illustration.” Any embodiment or design described herein as “exemplary” or “example” is not necessarily to be construed as preferred or advantageous over other embodiments or designs.

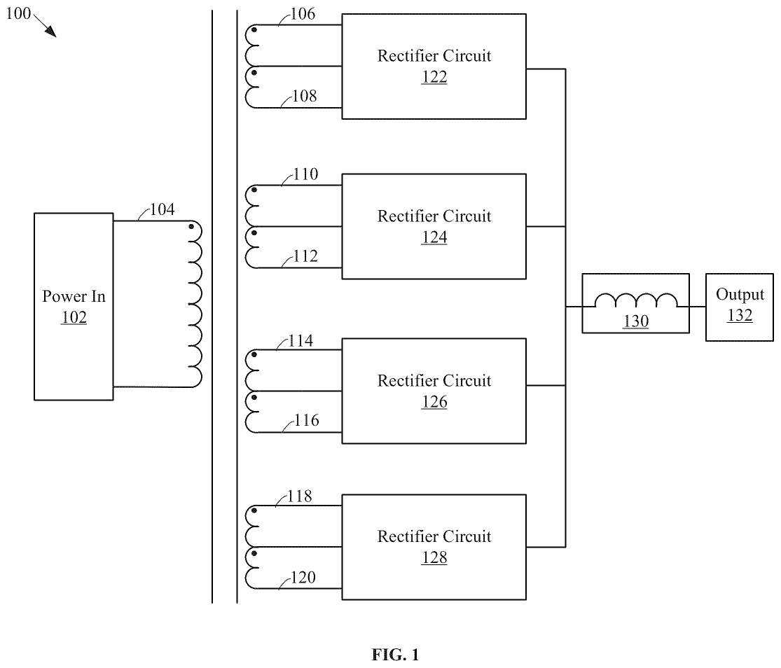

FIG. 1 shows a simplified block diagram of a compact integrated synchronous rectifier module 100, according to embodiments of the disclosure. The compact integrated synchronous rectifier module 100 is constructed to provide a high-power density and a high efficiency, as explained in more detail below. As shown in FIG. 1, the compact integrated synchronous rectifier module 100 is driven by an AC power source 102 that drives a primary transformer winding 104. The primary transformer winding 104 drives eight paired secondary windings 106-120. More specifically, secondary windings 106 and 108 are connected to first rectifier circuit 122, secondary windings 110 and 112 are connected to second rectifier circuit 124, secondary windings 114 and 116 are connected to third rectifier circuit 126 and secondary windings 118 and 120 are connected to fourth rectifier circuit 128. Each of first-fourth rectifier circuits 122-128, produces a DC output which is combined then filtered by inductor 130 and delivered to output 132.

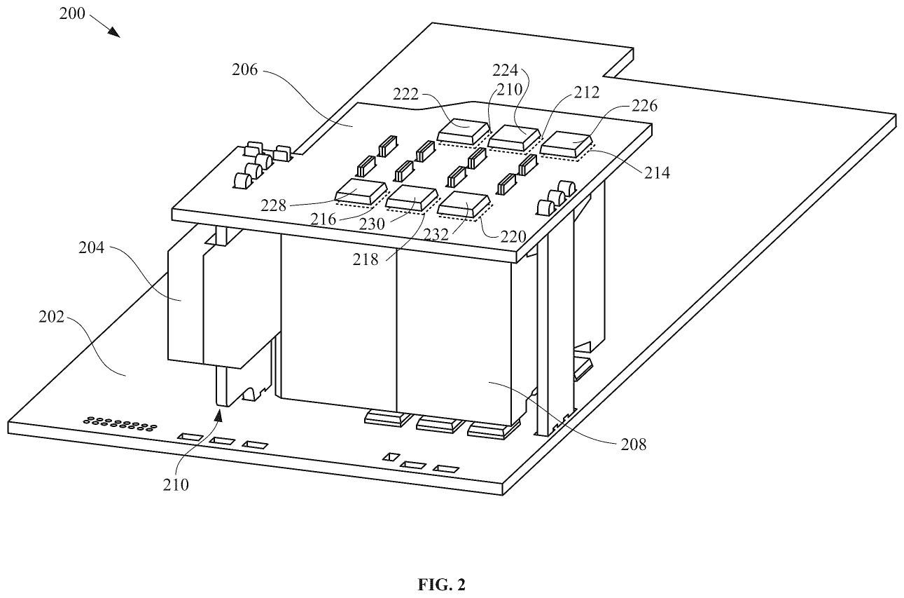

FIG. 2 illustrates a simplified isometric drawing of a compact integrated synchronous rectifier module 200 that may be constructed in accordance with the block diagram shown in FIG. 1. As shown in FIG. 2, power conversion module 200 comprises a top circuit board 206 that includes a first plurality of power switches 222 . . . 232, a bottom circuit board 202 that includes a second plurality of power switches (not shown in FIG. 2) and a transformer 208 positioned between the top and bottom circuit boards wherein the transformer includes a primary winding coupled to eight secondary windings via the top and bottom circuit boards. More specifically the first secondary is coupled in series with the second secondary via the top circuit board 206, the third secondary is coupled in series with the fourth secondary via the top circuit board, the fifth secondary is coupled in series with the sixth secondary via the bottom circuit board 202 and the seventh secondary is coupled with the eight secondary via the bottom circuit board, as described in more detail below. The first plurality of power switches rectify each respective output of the first, second, third and fourth secondary windings and the second plurality of power switches rectify the fifth sixth, seventh and eighth secondary windings.

The transformer and synchronous rectifier circuits are incorporated into a compact integrated package wherein the power switches are positioned in close proximity to the secondary windings (e.g., on top of and underneath the windings) for improved electrical performance (e.g., reduced parasitic inductance and capacitance). Spaces above and below the magnetics allows airflow through the module for convective cooling while conductive cooling e.g., via heatsinks or similar devices attached to the circuit boards and/or power switches, may also be used.

In the embodiment depicted in FIG. 2 there are six transistors 222, 224, 226, 228, 230, and 232 on a top surface of the top circuit board 206. The top transistors are in parallel in groups of three such that transistors 222, 224, and 226 are connected in parallel and transistors 228, 230, and 232 are connected in parallel. There are also six transistors 210, 212, 214, 216, 218, and 220 on the bottom side of the top board 206 which are shown as dashed lines. Transistors 210, 212, and 214 are connected in parallel and transistors 216, 218, 220 are connected in parallel. Similarly, the bottom circuit board 202 can be a two-sided board with components on the top of the board and on the bottom of the board. In the embodiment depicted in FIG. 2 there are six transistors (not shown in FIG. 2) on the top surface of the bottom circuit board 202 and six transistors on the bottom surface of the top circuit board (not shown in FIG. 2). In between the top circuit board 206 and the main circuit board 202 is a transformer 208. An inductor 204 connects the top circuit board 206 to the bottom circuit board 202. There is a space 210 between the inductor 204 and the transformer 208 to allow air flow.

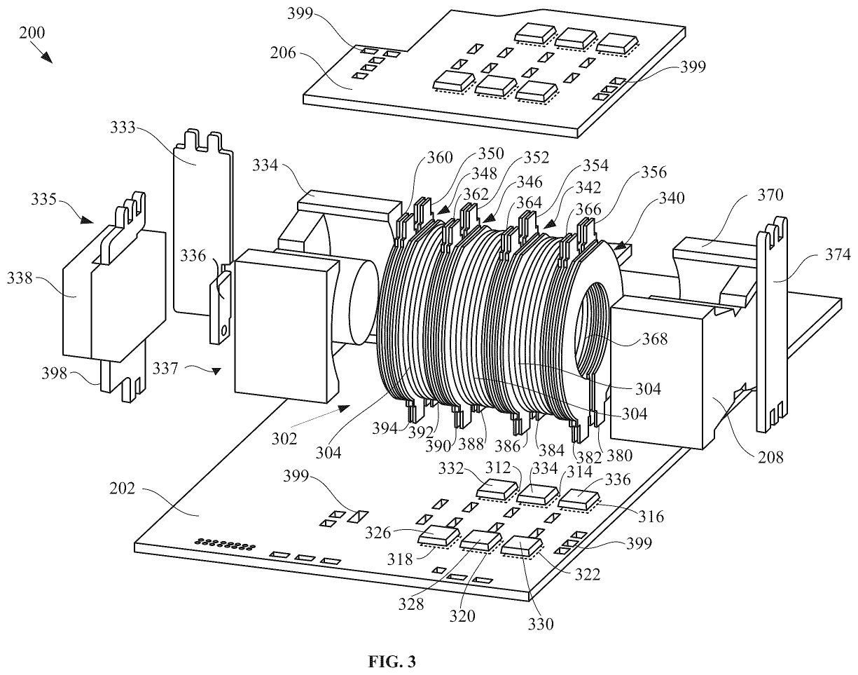

FIG. 3 is a simplified exploded view of the compact integrated synchronous rectifier module 200 shown in FIG. 2. As shown in FIG. 3, transformer 208 is shown in exploded view and includes a primary winding 304 that is distributed throughout the transformer, and a series of secondary windings, explained in more detail below. The secondary windings are each made of a first set of two plates that are laminated together with an electrically insulative film between them and each plate includes solder tabs at one end (e.g., a top or a bottom). The first set of two plates are laminated to a second set of two plates that are also laminated together with an electrically insulative film between them and each plate includes solder tabs at an opposite end of the first set of two plates. For example, if the first set of two plates are arranged such that their solder tabs are positioned at the top (e.g., to be attached to top circuit board 206) the second set of two plates are arranged such that their solder tabs are positioned at the bottom (e.g., to be attached to the bottom circuit board 202).

The first set of secondary windings 340 include two solder tabs 356, 366 that point up and two solder tabs 380, 382 that point down. Solder tabs 356 and 366 mate with top circuit board 206 while solder tabs 380 and 382 mate with bottom circuit board 202. The second set of secondaries 342 have two solder tabs 354, 364 that point up and two solder tabs 384, 386 that point down. The third set of secondaries 346 have two solder tabs 352, 362 that point up and two solder tabs 388, 390 that point down. The fourth set of secondaries 348 have two solder tabs 350, 360 that point up and two solder tabs 392, 394 that point down.

In some embodiments the transformer 208 includes a left ferromagnetic core 334 coupled to a right ferromagnetic core 370, where a portion of each core extends through the primary windings and the secondary windings 368. Left core 334 and right core 370 also include outer regions that at least partially enclose the primary and secondary windings.

The bottom circuit board 202 includes electronic six transistors 326-336 that are on a top surface of the bottom circuit board and six transistors 312-322 (shown in dashed lines in FIG. 3) that are on a bottom surface of the bottom circuit board. The six transistors on the top surface of the bottom circuit board include a first set of three transistors 332, 334, and 336 connected in parallel and a second set of three transistors 326, 328, and 330 connected in parallel. The six transistors on the bottom surface of the bottom circuit board 202 include a first set of three transistors 312, 314 and 316 connected in parallel and a second set of three transistors 318, 320, and 322 connected in parallel.

DC nodes 399 on the top board and on the main circuit board are connected by cross ties 374 for the negative connection and 333 for the positive connection. Cross tie 333 is made from an electrically conductive material (e.g., stamped copper) and includes a perpendicular extension 336 that extends from a body of the cross tie. An inductive element 335 includes an electrical conductor 398 partially enclosed by a ferrite bead 338, where the electrical conductor connects the top circuit board to the main circuit board.

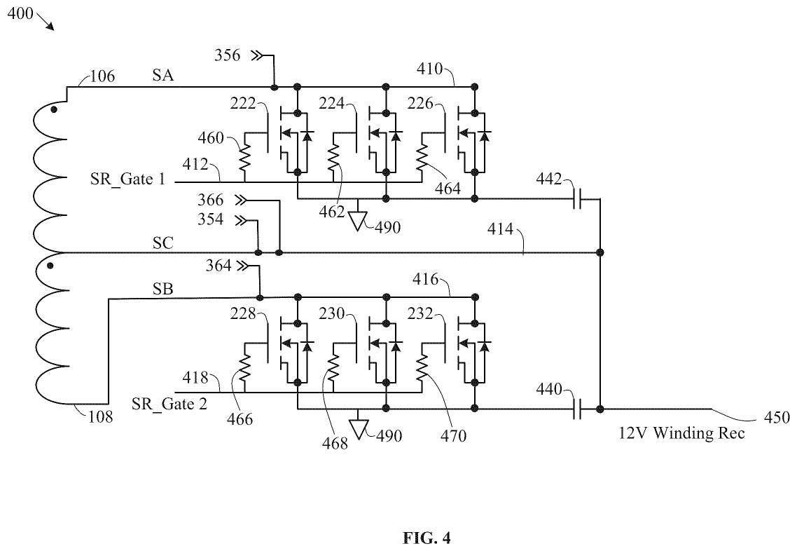

FIG. 4 is a simplified schematic of a circuit 400 formed in top circuit board 206 of synchronous rectifier 200 shown in FIGS. 2 and 3. In some embodiments circuit 400 may be formed at a top surface of circuit board 206 while in other embodiments it may be formed in one or more additional layers. The synchronous rectifier circuit 400 includes two secondary windings 106 and 108 in series connected to nodes SA, SC, and SB. SA 410 is connected to the secondary solder tab 356 (see FIG. 3). SC 414 is connected to secondary solder tabs 354 and 366 (see FIG. 3). SB 416 is connected to secondary solder tabs 364 (see FIG. 3). SA is connected to the drains of transistors 222, 224, and 226. The sources of transistors 222, 224, and 226 are connected in parallel and are connected to a first terminal of a capacitor 442 and to a main ret 490. A first gate driver line (SR_Gate 1) 412 is connected to resistor 460, 462, and 464. The other end of resistor 460 is connected to the gate of transistor 222, the other end of resistor 462 is connected to the gate of 224 and the other end of resistor 464 is connected to the gate of transistor 226. The second terminal of capacitor 442 is connected to one side of capacitor 440 and is connected to SC 414.

SB 416 is connected to the drains of transistors 228, 230, and 232. The sources of transistors 228, 230, and 232 are connected to each other and to the other side of capacitor 440 and to main ret 490. The signal SR_Gate 2 418 is connected to resistors 466, 468, and 470. The other end of resistor 466 is connected to the gate of transistor 228. The other end of resistor 468 is connected to the gate of transistor 230. The other side of resistor 470 is connected to the gate of transistor 232. Main ret 490 and winding rec are the DC outputs of the rectifier for each synchronous rectifier circuit.

In some embodiments synchronous rectifier circuit 400 operates as follows. Transistors 222, 224, and 226 act as a single transistor all switching simultaneously as the gate drives are driven commonly by the signal SR_Gate 1 412. The three transistors may be switched on when the output of the secondary winding 106 is negative. When the transistors 222, 224 and 226 are turned on, transistors 228, 230, and 232 are turned off. When the voltage across the secondary 106 becomes positive the transistors 222, 224 and 226 are turned off. Secondary 108 has the same polarity of secondary 106. When the polarity of secondary 108 becomes positive transistors 228, 230 and 232 are turned on by driving the gate drive signal SR_Gate 2 418. In each case the voltage of the main ret 490 is forced negative with respect to winding rec 450.

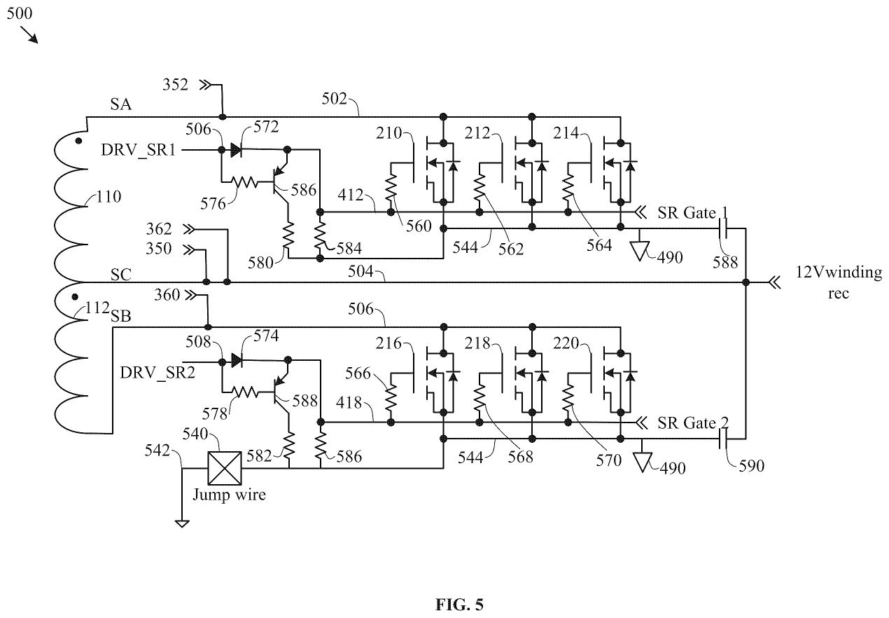

FIG. 5 is a simplified schematic of a circuit 500 formed in top circuit board 206 of synchronous rectifier 200 shown in FIGS. 2 and 3. In some embodiments circuit 500 may be formed at a bottom surface of top circuit board 206 while in other embodiments it may be formed in one or more additional layers. Circuit 500 is shown as rectifier circuit 124 in FIG. 1. The synchronous rectifier circuit 500 shows two secondary windings 110 and 112 in series connected to nodes SA 502, SC 504, and SB 506. SA 502 is connected to the secondary solder tab 352. SC 504 is connected to secondary solder tabs 362 and 350. SB 506 is connected to secondary solder tabs 360. SA 502 is connected to the drains of transistors 210, 212, and 214. The source of transistors 210, 212, and 214 are connected in parallel and are connected to one side of capacitor 588 and to main ret 490. The other side of capacitor 588 is connected to one side of capacitor 590 and is also connected to SC 504 solder tabs 362 and 350. SB 360 is connected to the drains of transistors 216, 218 and 220. The sources of transistors 216, 218, and 220 are connected in parallel to each other and are connected the other side of capacitor 590 as well as main ret 490.

A gate drive signal DRV_SR1 506 is connected to the anode of diode 572 and to base resistor 576. The other end of base resistor 576 is connected to the base of PNP transistor 586. The cathode of diode 572 is connected to the emitter of transistor 586, to the top of resistor 584, to one end of resistors 560, 562, and 564 and to SR_Gate 1 412. The other end of resistor 560 is connected to the gate of transistor 210. The other end of resistor 562 is connected to the gate of transistor 212. The other end of resistor 564 is connected to the gate of transistor 214. The other end of resistor 584 is connected to the bottom of resistor 580 and to main ret 490. The top of resistor 580 is connected to the collector of transistor 586.

A gate drive signal DRV_SR2 is connected to the anode of diode 574 and to base resistor 578. The other end of base resistor 578 is connected to the base of PNP transistor 588. The cathode of diode 574 is connected to the emitter of transistor 588 and to the top of resistor 582. The cathode of diode 574 is also connected to one end of resistors 566, 568, and 570 and is connected to SR_Gate 2 418. The other end of resistor 566 is connected to the gate of transistor 216. The other end of resistor 568 is connected to the gate of transistor 218. The other end of resistor 570 is connected to the gate of transistor 220. The other end of resistor 586 is connected to the bottom of resistor 582, to main ret 490 and to conductor 540 which in turn is connected to ground 542. The top of resistor 582 is connected to the collector of transistor 588.

The operation of the synchronous rectifier circuit 500 is as follows. Transistors 210, 212, and 214 act as a single transistor (e.g., synchronized operation) all switching simultaneously as the gate drives are driven by DRV_SR 1. DRV_SR1 drives PNP transistor 586 which in turn drives the signal SR Gate 1. The three transistors may be switched on when the output of the secondary winding 110 is negative. When the transistors 210, 212, and 214 are turned on the transistors 216, 218 and 220 also acting as a single transistor are turned off. When the voltage across the secondary 110 becomes positive the transistors 210, 212, and 214 are turned off. In some embodiments secondary 112 has the same polarity as secondary 108. When the polarity of secondary 112 becomes positive, transistors 216, 218 and 220 are turned on by driving the gate drive signal DRV_SR2 508. DRV_SR2 drives the PNP transistor 588 that drives this gate signal SR Gate 2 418. In each cycle the voltage of main ret 490 is forced negative. The minus (main ret 490) and plus voltage (winding rec) are connected via cross ties 374 and 333, respectively. The plus voltage—may be connected to the cross tie 335 with the ferrite bead 338 around it.

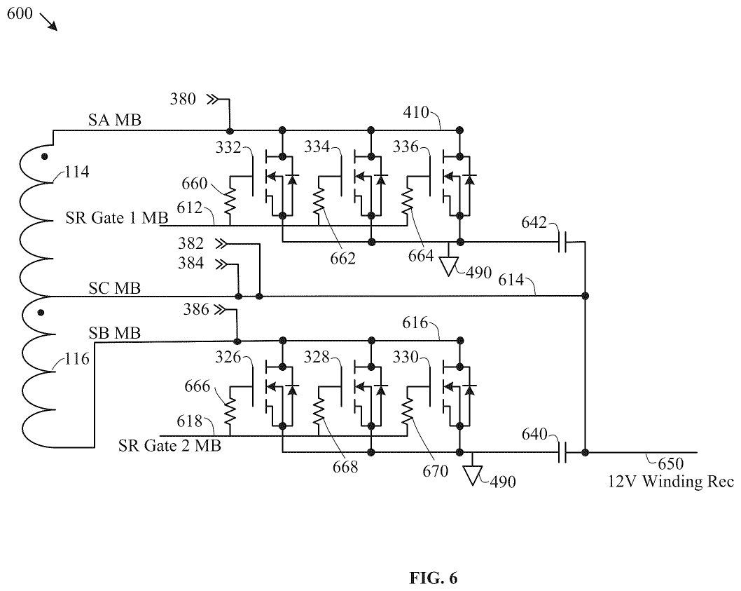

FIG. 6 is a simplified schematic of a circuit 600 formed on a top surface of bottom circuit board 202 of synchronous rectifier 200 shown in FIGS. 2 and 3. Circuit 600 is shown as rectifier circuit 126 in FIG. 1. The synchronous rectifier circuit 600 shows two secondary windings 114 and 116 in series connected to nodes SA_MB, SC_MB, and SB_MB. SA_MB is connected to the secondary solder tab 380. SC_MB is connected to secondary solder tabs 382 and 384. SB_MB is connected to secondary solder tabs 386. SA_MB is connected to the drains of transistors 332, 334, and 336. The sources of transistors 332, 334, and 336 are connected in parallel together and are connected to one end of capacitor 642 and to main ret 490. Signal SR Gate 1 MB 612 is connected to resistors 660, 662, and 664. The other end of resistor 660 is connected to the gate of transistor 332. The other end of resistor 662 is connected to the gate of 334. The other end of resistor 664 is connected to the gate of transistor 336. The other end of capacitor 642 is connected to one side of capacitor 640 and is connected to SC_MB 614 and the bottom of resistor 646. Power S_MB is connected to the drains of transistors 326, 328, and 330. The sources of transistors 326, 328, and 330 are connected in parallel to each other and the other side of capacitor 640 as well as to main ret 490. The signal SR Gate 2_MB 618 is connected to resistors 666, 668, and 670. The other end of resistor 666 is connected to the gate of transistor 326. The other end of resistor 668 is connected to the gate of transistor 328. The other side of resistor 670 is connected to the gate of transistor 330. The bottom of capacitor 674 and the bottom of capacitor 676 are connected to main ret 490.

The operation of the synchronous rectifier circuit 600 is as follows. Transistors 332, 334 and 336 act as a single transistor (e.g., synchronized operation) all switching at the same time as the gate drives are driven by SR_Gate 1 MB. The three transistors may be switched on when the output of the secondary winding 114 is negative. When the transistors 332, 334 and 336 are turned on, transistors 326, 328 and 330 are turned off. When the voltage across the secondary 114 becomes positive the transistors 332, 334 and 336 are turned off. In some embodiments, secondary 114 has the same polarity of secondary 116. When the polarity of secondary 114 becomes positive, transistors 326, 328 and 330 are turned on by driving the gate drives SR Gate 2 MB 618. The voltage of the main ret 490 is forced negative with respect to winding rec 450.

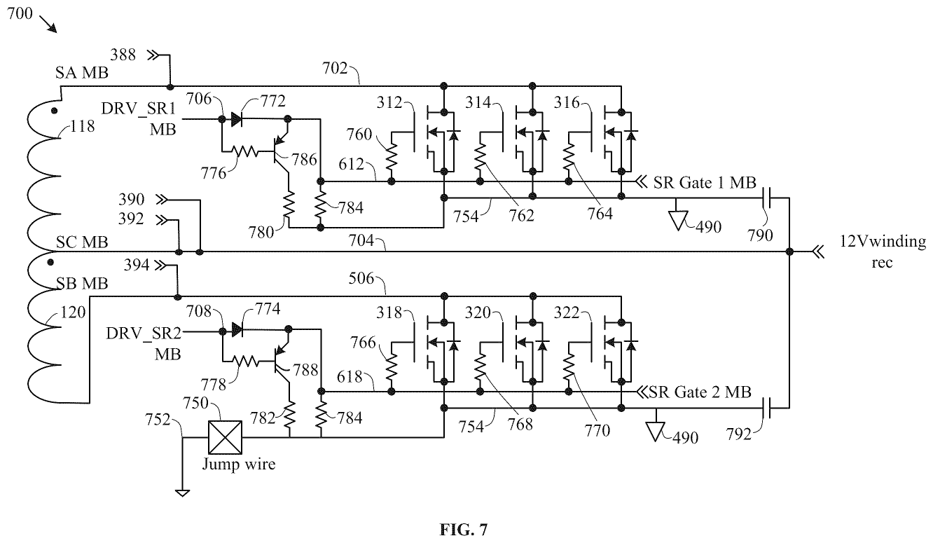

FIG. 7 is a simplified schematic of a circuit 700 formed on a bottom surface of bottom circuit board 202 of synchronous rectifier 200 shown in FIGS. 2 and 3. Circuit 700 is shown as rectifier circuit 124 in FIG. 1. The synchronous rectifier circuit 700 shows two secondary windings 118 and 120 connected in series and connected to nodes SA MB, SC MB, and SB MB. SA MB is connected to the secondary solder tab 388. SC MB is connected to secondary solder tabs 390 and 392. SB MB is connected to secondary solder tabs 394. SA MB is connected to the drains of transistors 312, 314, and 316. The sources of transistor 312, 314, and 316 are connected together in parallel and are connected to one side of capacitor 790 and to main ret 490. The other side of capacitor 790 is connected to one side of capacitor 792 and is also connected to SC_MB 704. SB_MB 394 is connected to the drains of transistors 318, 320, and 322. The sources of transistors 318, 320, and 322 are connected together and are connected the other side of capacitor 792 as well as main ret 490.

The gate drive signal DRV_SR1 MB 706 is connected to the anode of diode 772 and to one end of base resistor 776. The other end of base resistor 776 is connected to the base of PNP transistor 786. The cathode of diode 772 is connected to the emitter of transistor 786, to the top of resistor 784, to one end of resistors 760, 762, and 764 and also to SR_Gate 1 MB 612. The other end of resistor 760 is connected to the gate of transistor 312. The other end of resistor 762 is connected to the gate of transistor 314. The other end of resistor 764 is connected to the gate of transistor 316. The other end of resistor 784 is connected to the bottom of resistor 780 and to main ret 490. The top of resistor 780 is connected to the collector of transistor 786.

The gate drive signal DRV_SR2 MB 708 is connected to the anode of diode 774 and to one end of base resistor 778. The other end of base resistor 778 is connected to the base of PNP transistor 788. The cathode of diode 774 is connected to the emitter of transistor 788 and to the top of resistor 784. The cathode of diode 774 is also connected to one end of resistors 766, 768, and 770 and is connected to SR_Gate 2 MB 618. The other end of resistor 766 is connected to the gate of transistor 318. The other end of resistor 768 is connected to the gate of transistor 320. The other end of resistor 770 is connected to the gate of transistor 322. The other end of resistor 784 is connected to the bottom of resistor 782, to main ret 490 and to conductor 750 which in turn is connected to ground 752. The top of resistor 782 is connected to the collector of transistor 788.

The operation of the synchronous rectifier circuit 700 is as follows. Transistors 312, 314 and 316 act as a single transistor all switching simultaneously as the gate drives are driven by DRV_SR 1 MB 706. DRV_SR1 MB 706 drives PNP transistor 786 which in turn drives the signal SR Gate 1 MB. The three transistors may be switched on when the output of the secondary winding 118 is negative. When the transistors 312, 314 and 316 are turned on the transistors 318, 320 and 322 also acting as a single transistor are turned off. When the voltage across the secondary 118 becomes positive the transistors 312, 314 and 316 are turned off. Secondary 120 has the same polarity of secondary 118. When the polarity of secondary 120 becomes positive transistors 318, 320 and 322 are turned on by driving the gate drive signal DRV_SR2 MB 508. DRV_SR2 MB drives the PNP transistor 788 that drives this gate signal SR Gate 2 MB 618. In each cycle the voltage of the main ret 490 is forced negative. The minus (main ret 490) and plus voltage (winding rec) is connected via cross ties 374 and 333 respectively.

A person of skill in the art, with the benefit of this disclosure, will appreciate that, in other embodiments, any suitable number of parallel transistors and secondary windings may be used. Further, other variations of packaging architecture and geometry are within the scope of this disclosure.

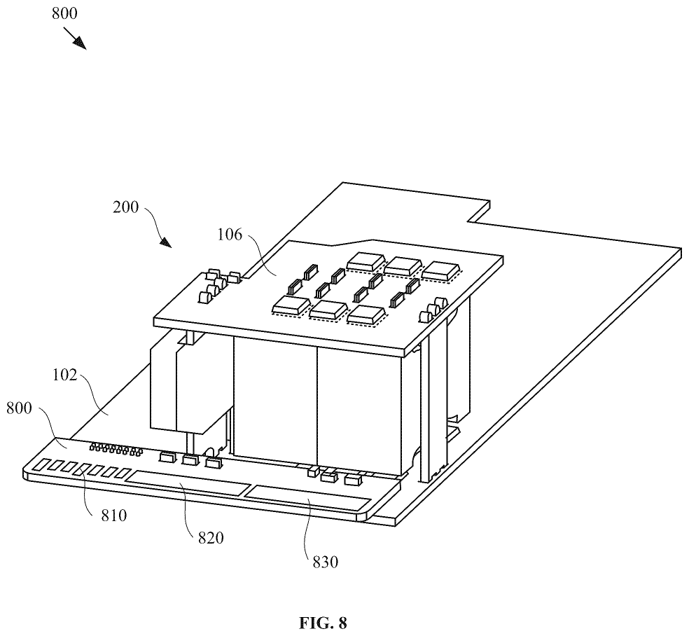

FIG. 8 illustrates a simplified isometric drawing of a compact integrated synchronous rectifier module 200 shown in FIGS. 1-7. Rectifier module 200 may be or may include any of the components, features, or characteristics of any of the rectifier modules described herein. In this particular embodiment a connector board 800 is attached to the main circuit board 102. Connector board 102 has card-edge connections 820 and 830 for power and card-edge connections 810 for control connections.

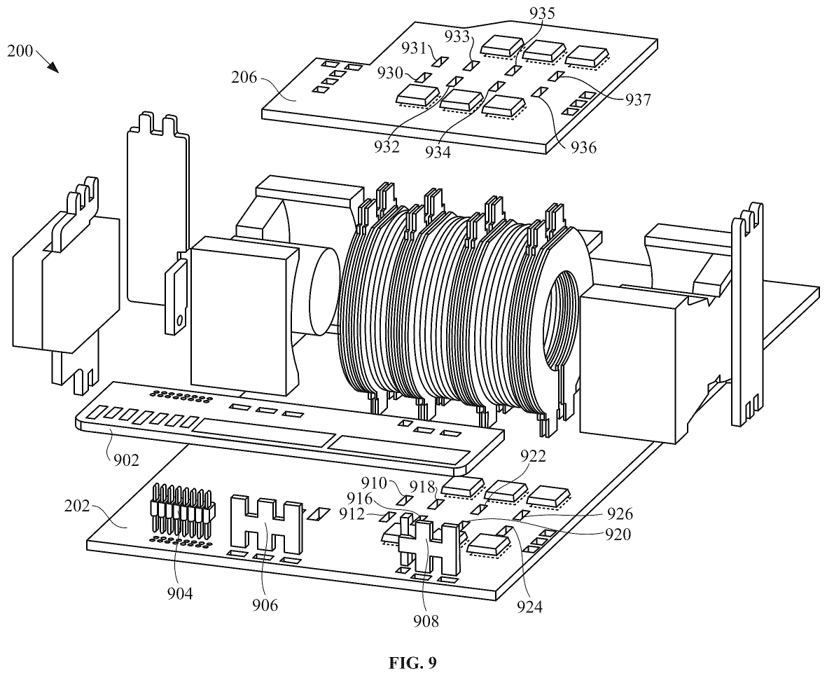

FIG. 9 illustrates a simplified isometric exploded view rectifier module 200 and connector board 800 shown in FIG. 8. In some embodiments the top circuit board 206 has 8 slots that connect with the 8 solder tabs for the secondary windings. Slot 937 is connected to tab 356. Slot 936 is connected to tab 366. Slot 935 is connected to tab 354. Slot 934 is connected to tab 364. Slot 933 is connected to tab 352. Slot 932 is connected to tab 362. Slot 931 is connected to tab 350. Slot 930 is connected to tab 360.

The transformer is also coupled to slots formed in the main circuit board 202. Slot 926 is connected to tab 380. Slot 924 is connected to tab 382. Slot 922 is connected to tab 384. Slot 920 is connected to tab 386. Slot 918 is connected to tab 388. Slot 916 is connected to tab 390. Slot 910 is connected to tab 392. Slot 912 is connected to tab 394. The drawing also shows connections for power and control from the main circuit board 202 and the interconnect board 902. Busbar 906 and 908 can be used for power and interconnections 904 can be used for control that mate directly above to board 902.

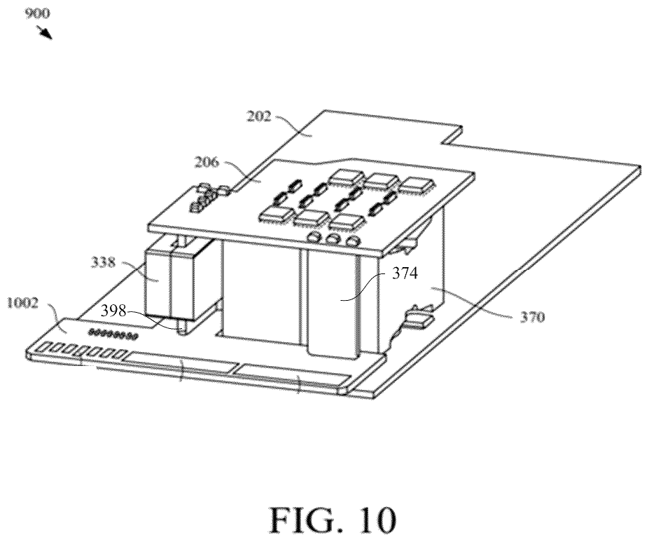

FIG. 10 illustrates a simplified isometric drawing of another embodiment of a compact integrated synchronous rectifier module 200 shown in FIGS. 1-7 that is similar to the rectifier module shown in FIG. 8. Rectifier module 900 may be or may include any of the components, features, or characteristics of any of the rectifier modules described herein with like reference numbers denoting like elements. Similar to the rectifier module 800 shown FIG. 8 a connector board 1002 is attached to the main circuit board 202. Connector board 1002 may enable direct connections to the outputs of the rectifier module without going through the main circuit board, minimizing interconnection parasitics, improving performance and reducing transmission loss. In this embodiment, for example, a cross tie 374 and an electrical conductor, such as shown in FIG. 3 connect directly to the connector board 1002.

In some embodiments the switches and/or diodes may be fabricated with gallium nitride GaN, silicon carbide SiC, a III-V semiconductor material and/or silicon. In various embodiments one or more of the switches may be field-effect devices including but not limited to enhancement mode or depletion mode devices.

One of ordinary skill in the art will appreciate that various features and aspects of the Silicon Rectifier for LLC applications can be changed, modified and manipulated which are within the scope of this disclosure.

In the foregoing specification, embodiments of the disclosure have been described with reference to numerous specific details that can vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction. The specific details of particular embodiments can be combined in any suitable manner without departing from the spirit and scope of embodiments of the disclosure.

Additionally, spatially relative terms, such as “bottom or “top” and the like can be used to describe an element and/or feature's relationship to another element(s) and/or feature(s) as, for example, illustrated in the figures. It will be understood that the spatially relative terms are intended to encompass different orientations of the device in use and/or operation in addition to the orientation depicted in the figures. For example, if the device in the figures is turned over, elements described as a “bottom” surface can then be oriented “above” other elements or features. The device can be otherwise oriented (e.g., rotated 90 degrees or at other orientations) and the spatially relative descriptors used herein interpreted accordingly.

Terms “and,” “or,” and “an/or,” as used herein, may include a variety of meanings that also is expected to depend at least in part upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, B, C, AB, AC, BC, AA, AAB, ABC, AABBCCC, etc.

Reference throughout this specification to “one example,” “an example,” “certain examples,” or “exemplary implementation” means that a particular feature, structure, or characteristic described in connection with the feature and/or example may be included in at least one feature and/or example of claimed subject matter. Thus, the appearances of the phrase “in one example,” “an example,” “in certain examples,” “in certain implementations,” or other like phrases in various places throughout this specification are not necessarily all referring to the same feature, example, and/or limitation. Furthermore, the particular features, structures, or characteristics may be combined in one or more examples and/or features.

In the preceding detailed description, numerous specific details have been set forth to provide a thorough understanding of claimed subject matter. However, it will be understood by those skilled in the art that claimed subject matter may be practiced without these specific details. In other instances, methods and apparatuses that would be known by one of ordinary skill have not been described in detail so as not to obscure claimed subject matter. Therefore, it is intended that claimed subject matter not be limited to the particular examples disclosed, but that such claimed subject matter may also include all aspects falling within the scope of appended claims, and equivalents thereof.

What is claimed is:

1. A power conversion module comprising:
a first circuit board including a first plurality of power switches;
a second circuit board including a second plurality of power switches;
a transformer including:
a primary winding magnetically coupled to first and second secondary windings, wherein the first secondary winding is connected to the first plurality of power switches and wherein the second secondary winding is connected to the second plurality of power switches; and
a magnetic core extending through the primary winding and through the first and second secondary windings;
wherein the primary winding receives an AC voltage and wherein the first plurality of power switches and the second plurality of power switches rectify the AC voltage.

2. The power conversion module of claim 1 wherein the transformer is positioned between the first circuit board and the second circuit board.

3. The power conversion module of claim 1 wherein the transformer further includes: a third secondary winding connected to the first plurality of power switches and a fourth secondary winding connected to the second plurality of power switches.

4. The power conversion module of claim 3 wherein the first secondary winding is positioned adjacent the second secondary winding and wherein the third secondary winding is positioned adjacent the fourth secondary winding.

5. The power conversion module of claim 3 wherein at least a portion of the primary winding is positioned between the first secondary winding and the third secondary winding.

6. The power conversion module of claim 1 wherein a first set of the first plurality of power switches are connected in parallel and wherein a second set of the second plurality of power switches are connected in parallel.

7. The power conversion module of claim 1 further comprising first and second electrical conductors electrically coupled to the first and second circuit boards.

8. The power conversion module of claim 1 wherein the first and second pluralities of power switches comprise III-V semiconductor devices.

9. A power conversion module comprising:
a first circuit board including a first plurality of power switches;
a second circuit board including a second plurality of power switches; and
a transformer including a primary winding coupled to first, second, third, fourth, fifth, sixth, seventh and eighth secondary windings, wherein the first secondary winding is coupled in series with the second secondary winding via the first circuit board, the third secondary winding is coupled in series with the fourth secondary winding via the first circuit board, the fifth secondary winding is coupled in series with the sixth secondary winding via the second circuit board and the seventh secondary winding is coupled in series with the eighth secondary winding via the second circuit board;
wherein the primary winding receives an AC voltage and wherein the first and second pluralities of power switches rectify the AC voltage.

10. The power conversion module of claim 9 wherein the transformer is positioned between the first circuit board and the second circuit board.

11. The power conversion module of claim 9 wherein the first, second, third and fourth secondary windings are connected to the first plurality of power switches and wherein the fifth, sixth, seventh and eighth secondary windings are connected to the second plurality of power switches.

12. The power conversion module of claim 11 wherein the first secondary winding is positioned adjacent the third secondary winding and wherein the second secondary winding is positioned adjacent the fourth secondary winding.

13. The power conversion module of claim 12 wherein at least a portion of the primary winding is positioned between the first secondary winding and the third secondary winding.

14. The power conversion module of claim 9 wherein a first set of the first plurality of power switches are connected in parallel and wherein a second set of the second plurality of power switches are connected in parallel.

15. The power conversion module of claim 9 further comprising first and second electrical conductors electrically coupled to the first and second circuit boards.

16. The power conversion module of claim 9 wherein the first and second pluralities of power switches comprise III-V semiconductor devices.

17. A method of forming a power conversion module the method comprising:
forming a first circuit board;
attaching a first plurality of power switches to the first circuit board;
forming a second circuit board;
attaching a second plurality of power switches to the second circuit board;
forming a transformer including a primary winding coupled to first, second, third, fourth, fifth, sixth, seventh and eighth secondary windings;
coupling the first secondary winding in series with the second secondary winding via the first circuit board;
coupling the third secondary winding in series with the fourth secondary winding via the first circuit board;
coupling the fifth secondary winding in series with the sixth secondary winding via the second circuit board;
coupling the seventh secondary winding in series with the eighth secondary winding via the second circuit board; and
receiving an AC voltage with the primary winding and rectifying the AC voltage with the first and second pluralities of power switches.

18. The method of claim 17 further comprising inserting a ferromagnetic material within the primary winding and the first through eighth secondary windings.

19. The method of claim 17 wherein the transformer is positioned between the first circuit board and the second circuit board.

20. The method of claim 17 further comprising forming the first and second pluralities of switches from a III-V semiconductor material.
